(19) United States
(12) Patent Application Publication
(10) Pub. No.: US 2008/0279984 A1
(43) Pub. Date: Nov. 13, 2008

(54) Method for producing potato products

(75) Inventors: Lisbeth Kalum, Vaerlose (DK); Steffen Ernst, Bronshoj (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 12/015,906

(22) Filed: Jan. 17, 2008

Related U.S. Application Data
(60) Provisional application No. 60/886,318, filed on Jan. 24, 2007.

(30) Foreign Application Priority Data
Jan. 18, 2007 (EP) 07100726.4

(51) Int. Cl. A23L 1/217; A23L 1/2165

(52) U.S. Cl. 426/52; 426/637

(57) ABSTRACT

The present invention relates to methods for increasing the content of resistant starch in a potato product by enzymatic treatment. The invention further relates to potato products having an increased content of resistant starch.

### CROSS-REFERENCE TO RELATED APPLICATIONS

This application claims priority or the benefit under 35 U.S.C. 119 of European application No. 07100726.4 filed Jan. 18, 2007 and U.S. provisional application No. 60/886,318 filed Jan. 24, 2007, the contents of which are fully incorporated herein by reference.

### FIELD OF INVENTION

The present invention relates to a method for increasing the content of resistant starch in a potato product.

The invention further relates to a potato product obtainable by the method according to the invention.

### BACKGROUND OF THE INVENTION

Carbohydrates constitute one of the basic ingredients in the diet of many animals, e.g. in the diet of humans. Frequently the primary source for providing carbohydrate is starch, which is the main constituent of e.g. corn, cereals, yams, rice and potatoes. Starch is composed of two types of polysaccharide molecules, amylose, a mostly linear and flexible polymer of D-anhydroglucose units linked by alpha-1,4-D-glucosidic bonds, and amylopectin, a branched polymer of linear chains linked by alpha-1,6-D-glucosidic bonds. Starch is digested predominantly in the small intestine of most mammals by the enzyme alpha-amylase. Starch and starch containing products constitute a major source of energy and excessive consumption of starch or starch containing products may lead to weight gain and in severe cases obesity. Obesity is becoming a major problem for the human population throughout the world.

“Resistant starch” may be defined as starch that resists digestion and absorption in the small intestine of e.g. mammals. Ingested resistant starch passes into the large intestine where it is fermented by colonic microflora to short chain fatty acids, particularly butyrate, and gases. Resistant starch may be used in foods, including medical foods and dietary supplements, to maintain colonic health and mucosal integrity. Resistant starch is known as a prebiotic. Further, as it is not utilized until it reaches the large intestine where it is fermented to short chain fatty acids, resistant starch has a reduced caloric value. The reduction in available or glycemic carbohydrate in the small intestine has been linked to improved blood glucose and insulin control, with associated benefits for weight management. Research also indicates that resistant starches may contribute to maintaining a healthy immune system in humans.

Resistant starch may be produced from pure starch by e.g. enzymatic treatment, and a number of processes for increasing the rate of this transformation are known.

Products containing resistant starch are known to retain physical properties and properties as regards taste, smell, texture and general appearance that are generally acceptable for consumers and for human consumption.

However, the enzymatic production of resistant starch has so far only proven successful using essentially pure starch as starting material as seen in U.S. Pat. No. 6,929,817. Production of food products having an increased content of resistant starch using enzymatic processes “in situ” has so far not been reported. Accordingly, one object of the present invention was to provide food products having an increased content of resistant starch by using enzymatic processes in situ.

### Definitions

In the context of the present invention a “potato pre-product” means any product directly derived from raw potatoes by means of mechanical processes (e.g. washing and or peeling) and optionally treatment with heat and/or water or aqueous compositions (e.g. washing, cooking, blanching or steaming). In this context “directly derived” means only that the potato product has not been altered substantially with respect to constituents and ratios between constituents (with the exception of water, which may possibly be removed by drying or added by optional treatments with aqueous compositions as stated above) in comparison to constituents and ratios between constituents of the potato from which the potato pre-product according to the invention is derived. In one embodiment the “potato pre-product” may simply be washed raw potatoes. In the context of the present invention a “potato pre-product” may alternatively be defined as a product derived from potatoes which still retain the essential structures and composition of potatoes e.g. with regard to presence of cell walls visible by light microscopy. Thus “potato pre-products” may be defined as products wherein the majority of the potato pre-products comprise material consisting of cell walls and material situated within cell walls. Pure or essentially pure potato starch is not to be regarded as “potato pre-products” according to the invention. Production of such pure or essentially pure potato starch typically involves grinding or milling potatoes to disintegrate the cells and release the starch. Also, the constituents and ratios between constituents in such pure or essentially pure potato starch is typically different from the constituents and ratios between constituents of the potatoes from which it is derived, i.e. the content of starch is percentage-wise higher than in the potatoes.

In the context of the present invention a “potato product” means any potato product which may be obtained by treating a “potato pre-product” according to the present invention. Potato products may additionally have been subjected to other optional treatment steps such as mechanical treatment steps like cutting, mashing, molding, pressing. Other examples of further treatment steps include treatment steps like frying, deep-frying, par-frying, cooking, bleaching, baking and leaching to obtain the potato product. Suitable examples of potato products produced according to the invention are potato granules, potato flakes, sliced potato chips, fabricated potato chips, extruded potato snacks, ground or crushed dehydrated potato dice and slice pieces, french fries (sometimes also referred to as pommes frites), par-fried potato products, potato croquettes, potato nuggets, industrially pre-cooked potatoes, and mashed potato products such as cooled mashed potatoes and instant mashed potatoes. These examples include products that are not completely cooked (pre-cooked products) as well as finished products for direct consumption.

In the context of the present invention “in situ” means that the potato pre-products are processed enzymatically according to the invention as an integrated part of the process of converting the potato pre-products into potato products according to the invention.

In the context of the present invention “resistant starch” may be defined as a starch that resists digestion and absorption in the small intestine of e.g. mammals. Resistant starch (RS) may be classified into four categories depending on the causes of resistance. RS1 is a physically inaccessible starch due to entrapment of granules within a protein matrix or within a plant cell wall. RS2 is a granular starch that resists digestion by pancreatic alpha-amylase. RS3 is a retrograded, nongranular starch or starch food. RS4 is a resistant starch that has linkages other than alpha-1,4- and alpha-1,6-D-glucosidic bonds. Resistant starch in the context of the present invention includes, but is not limited to these four categories.

In the context of the present invention “debranching enzymes” are enzymes that hydrolyse alpha-1,6-glucosidic linkages in starch. The group comprises, e.g., “amylo-alpha-1,6-glucosidase” (EC 3.2.1.33), “Pullulanase” (EC 3.2.1.41), “Isoamylase” (EC 3.2.1.68) and “Limit dextrinase” (EC 3.2.1.142).

“Amylo-alpha-1,6-glucosidase” (EC 3.2.1.33) hydrolyses unsubstituted alpha-1,6-glucose residues that form branch points on an alpha-1,4-linked glucose chain. The enzyme activity found in mammals and yeast is in a polypeptide chain containing two active centres. The other activity is similar to that of 4-alpha-glucanotransferases (EC 2.4.1.25), which acts on the glycogen phosphorylase limit dextrin chains to expose the single glucose residues, which the 6-alpha-glucosidase activity can then hydrolyse. Other names of amylo-alpha-1,6-glucosidases are e.g. amylo-1,6-glucosidase, dextrin 6-alpha-D-glucosidase, amylopectin 1,6-glucosidase and dextrin-1,6-glucosidase. The systematic name is glycogen phosphorylase-limit dextrin alpha-1,6-glucohydrolase.

“Pullulanase” (EC 3.2.1.41) hydrolyses alpha-1,6-D-glucosidic linkages in pullulan (a linear polymer of alpha-1,6-linked maltotriose units) and in amylopectin and glycogen, and the alpha- and beta-limit dextrins of amylopectin and glycogen. Other name(s) of pullulanase are e.g amylopullulanase, amylopectin 6-glucanohydrolase; bacterial debranching enzyme; debranching enzyme; alpha-dextrin endo-1,6alpha-glucosidase; R-enzyme. The systematic name is “pullulan alpha-1,6-glucanohydrolase”. Enzymes belonging to this class may comprise a carbohydrate binding module (CBM).

“Isoamylase” (EC 3.2.1.68) hydrolyses alpha-1,6-glucosidic linkages in glycogen, amylopectin and their beta-limit dextrins. The systematic name is glycogen alpha-1,6-glucanohydrolase. Isoamylase differs from pullulanase (EC 3.2.1.41) and limit dextrinase (EC 3.2.1.142) by its inability to hydrolyse pullulan, and by limited action on alpha-limit dextrins. Maltose is the smallest sugar it can release from an alpha-1,6-linkage.

“Limit dextrinase” (EC 3.2.1.142) hydrolyse alpha-1,6-D-glucosidic linkages in alpha- and beta-limit dextrins of amylopectin and glycogen, and in amylopectin and pullulan. The systematic name is dextrin alpha-1,6glucanohydrolase and other common names include R-enzyme; amylopectin-1,6glucosidase.

A “catalytic starch debranching domain” is intended to mean a part of a debranching enzyme, which part is responsible for the catalytic activity of the complete enzyme. Thus a catalytic starch debranching domain may be a part of or the complete debranching enzyme.

“Carbohydrate binding domains” are protein structures capable of binding a carbohydrate, usually with non-covalent bindings. Carbohydrate binding domains include domains binding polysaccharides such as cellulose, xylan or starch. Several carbohydrate binding domains have been described in the literature, and have been grouped in families, for review see Boraston et al. (2004) Biochem. J. 382: 769-781 and http://afmb.cnrs-mrs.fr/CAZY/index.html for the grouping of CBM families.

A “starch binding domain” is a carbohydrate binding domain having specificity for starch, in particular raw starch. Starch binding domains are found in at least the carbohydrate binding domain families CBM-20, CBM-21, CBM-25, CBM-26, CBM-34, CBM-41 and CBM-45.

A “linker sequence” is a proteinaceous part separating, e.g., the catalytic starch debranching domain from the carbohydrate binding domain without interfering with the activity of the two domains.

### Short Description of the Invention

Surprisingly it has been shown during the course of the experiments leading to the present invention, that potato products having an increased content of resistant starch can be produced from potato pre-products using an enzymatic process. Particularly it has been shown that potato products having an increased content of resistant starch can be produced using enzymatic processes “in situ”, meaning that the potato products produced according to the present invention are derived directly from potato pre-products, having essentially the composition of raw potatoes (with the possible exception of the content of water which may have been altered).

Accordingly the present invention relates to a method for increasing the content of resistant starch in a potato product said method comprising the steps of:
a. providing an aqueous composition comprising a potato pre-product,
b. adjusting the temperature of the composition of step a) to a temperature suitable for enzymatic treatment of the potato pre-product by debranching enzymes,
c. treating the composition with one or more debranching enzymes, and
d. holding the enzyme treated potato pre-product at a temperature of between −2 and 50° C.

Preferably, step d) is performed at a temperature and for a time period which induces formation of resistant starch in the enzyme treated potato pre-product, i.e. step d) is performed at a temperature and for a time period sufficient to increase the content of resistant starch in the enzyme treated potato pre-product.

In a preferred aspect, the enzyme treated potato pre-product is held at a temperature of between −2 and 30° C., such as at a temperature of between −2 and 10° C.

In one aspect, the present invention relates to a method for increasing the content of resistant starch in a potato product said method comprising the steps of:
a. providing an aqueous composition comprising a potato pre-product,
b. adjusting the temperature of the composition of step a) to a temperature suitable for enzymatic treatment of the potato pre-product by debranching enzymes,
c. treating the composition with one or more debranching enzymes, and
d. cooling the resulting potato product to a temperature of between −2 and 30° C., such as to a temperature of between −2 and 10° C.

In step d), the enzyme treated potato pre-product is held for a time period which induces formation of resistant starch in the enzyme treated potato pre-product, i.e. for a time period sufficient to increase the content of resistant starch in the enzyme treated potato pre-product. Preferentially, the treatment time in step d) is between 10 minutes and 20 hours.

The potato pre-product used in a method according to the present invention is preferably derived directly from raw potatoes.

It has been shown that an additional increase in the content of resistant starch in the potato product produced according to the invention can be obtained by a subsequent treatment step wherein the enzyme treated potato pre-product is heated in a second heating step.

It has been shown that an additional increase in the content of resistant starch in the potato product produced according to the invention can be obtained by a subsequent treatment step wherein the enzyme treated potato pre-product is frozen.

It has been shown that an additional increase in the content of resistant starch in the potato product produced according to the invention can be obtained by a subsequent treatment step wherein the enzyme treated potato pre-product is freeze-dried.

It has been shown that the increase in the content of resistant starch in the potato product produced according to the invention may be obtained by enzymatic treatment using debranching enzymes. Especially promising enzymes for use according to the invention are enzymes selected among the group comprising amylo-alpha-1,6-glucosidase, limit dextrinase, pullulanase and isoamylase. In one embodiment, promising results were obtained using pullulanase. In one embodiment, promising results were obtained using isoamylase.

The potato product produced according to the invention may comprise between 4% and 60% resistant starch. Preferably the potato starch product produced according to the invention comprises more than 5% resistant starch. More preferably the potato starch product produced according to the invention comprise more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch

In the context of the present invention, unless otherwise specified, a percentage-wise amount of resistant starch in a potato product is the percentage of the total amount of starch which is resistant starch. I.e., unless otherwise specified, a product comprising “more than 5% resistant starch” means a product wherein more than 5% of the total amount of starch in the product is resistant starch. For any potato product according to the present invention, the skilled person will know, or be able to find out by analysis, the total amount of starch as percentage of total dry matter. Therefore, if a person skilled in the art knows the percentage-wise amount of resistant starch, i.e. the percentage of total starch which is resistant starch, he/she will be able to calculate or estimate the amount of resistant starch as a percentage of the total dry matter. And vice-versa if a person skilled in the art knows the amount of resistant starch as a percentage of the total dry matter he/she will be able to calculate or estimate the percentage-wise amount of resistant starch, i.e. the percentage of total starch which is resistant starch.

A further aspect of the present invention relates to a mashed potato product, e.g. a cooled mashed potato product or an instant mashed potato product, comprising more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch.

A still further aspect of the present invention relates to industrially pre-cooked potatoes, such as vacuum packed chilled cooked potatoes, comprising more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch.

A still further aspect of the present invention relates to french fries (also known as pommes frites) comprising more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch.

A still further aspect of the present invention relates to a potato chips product, e.g. sliced potato chips or fabricated potato chips, comprising more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch.

### DETAILED DESCRIPTION OF THE INVENTION

The present invention relates to a method for increasing the content of resistant starch in a potato product said method comprising the steps of providing an aqueous composition comprising the potato pre-product, adjusting the temperature of the provided composition to a temperature suitable for enzymatic treatment of the potato pre-product by debranching enzymes, treating the composition with one or more debranching enzymes and holding the enzyme treated potato pre-product at a temperature of between −2 and 50° C.

In a preferred embodiment the enzyme treated composition is cooled to a temperature of between −2 and 30° C. and kept at such temperature for a time period sufficient to induce retrogradation, i.e. to induce formation of resistant starch. In a more preferred embodiment the composition is cooled to a temperature of between −2 and 10° C.

In the methods of the present invention, the potato may by of any variety and/or cultivar including, but not limited to Agata, Agria, Alex, Amadeus, Arno, Artana, Asparges, Asva, Atlantic, Balanse, Berber, Bintje, Burren, Calla, Carrera, Centennial Russet, Dali, Danva, Desiree, Ditta, Exempla, Exquisa, Fakse, Filea, Folva, Fontane, Godiva, Green Mountain, Hamlet, Hanna, Hansa, Hela, Imperia, Inova, Jaerla, Jutlandia, Kardal, Kardent, Karida, Kamico, Kennebec, Kenva, King Edward, Kuras, Lady Rosetta, Laura, Liva, Marabel, Marion, Mercury, Milva Revelino, Minea, Nicola, Norchip, Norgold Russet “BC”, Norland, Octavia, Oleva, Panda, Posmo, Primula, Producent, Raja, Raja Bonanza, Red Pontiac, Red Warba, Revelino, Russet Burbank, Sava, Sebago, Secura, Senator, Seresta, Shepody, Sibu, Sieglinde, Sirtema, Stefano, Superior, Sydens Dronning, Symfonia, Tertus, Timate, Tivoli, Torva, Ukama, Victoria, Vivaldi, and White Rose.

Preferably, the potato pre-product is derived directly from a raw potato.

A preferred potato product produced according to the invention may be a product selected among the group comprising potato granules, potato flakes, sliced potato chips, fabricated potato chips, extruded potato snacks, ground or crushed dehydrated potato dice and slice pieces, french fries (sometimes also referred to as pommes frites), par-fried potato products, potato croquettes, potato nuggets, industrially pre-cooked potatoes (e.g. vacuum packed chilled cooked potatoes), and mashed potato products such as cooled mashed potatoes and instant mashed potatoes.

Thus, in one embodiment the potato product consists of potato granules. Preferably the potato granule product produced according to the invention comprises more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch. Thus, the invention in this embodiment provides a potato granule product which has beneficial effects in that it contains more resistant starch than the previously known potato granule products.

In one embodiment the potato product consists of potato flakes. Preferably the potato flake product produced according to the invention comprises more than 6%, such as more than 7, 8, 9, 10, 11,12,13,13,14, 15,16, 17, 18, 19, 20,21, 22, 23, 24, 25, 26, 27,28, 29, 30, 31, 32, 33, 34, 35, 36, 37, 38, 39, 40% resistant starch. Thus, the invention in this embodiment provides a potato flake product which has beneficial effects in that it contains more resistant starch than the previously known potato flake products.

In one embodiment the potato product consists of ground dehydrated potato dice and slice pieces. Preferably the ground dehydrated potato dice and slice pieces produced according to the invention comprise more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch. Thus, the invention in this embodiments provides a ground dehydrated potato dice and slice piece product which has beneficial effects in that it contains more resistant starch than the previously known ground dehydrated potato dice and slice piece products.

In one embodiment the potato product consists of crushed dehydrated potato dice and slice pieces. Preferably the crushed dehydrated potato dice and slice pieces produced according to the invention comprise more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch. Thus, the invention in this embodiments provides a crushed dehydrated potato dice and slice piece product which has beneficial effects in that it contains more resistant starch than the previously known crushed dehydrated potato dice and slice piece products.

In one embodiment the potato product consists of french fries. Preferably the french fries product produced according to the invention comprises more than 6%, such as more than 7, 8, 9, 10, 11,12,13,13,14, 15, 16,17,18, 19, 20,21, 22, 23,24,25,26, 27,28, 29, 30, 31, 32, 33, 34, 35, 36, 37, 38, 39, 40% resistant starch. Thus, the invention in this embodiment provides a french fries product which has beneficial effects in that it contains more resistant starch than the previously known french fries products.

In one embodiment the potato product consists of sliced potato chips. Preferably the sliced potato chips product produced according to the invention comprises more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch. Thus, the invention in this embodiment provides a sliced potato chips product which has beneficial effects in that it contains more resistant starch than the previously known sliced potato chips products.

In one embodiment the potato product consists of fabricated potato chips. Preferably the fabricated potato chips product produced according to the invention comprises more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch. Thus, the invention in this embodiment provides a fabricated potato chips product which has beneficial effects in that it contains more resistant starch than the previously known fabricated potato chips products.

In one embodiment the potato product is a par-fried potato product. Preferably the par-fried potato product produced according to the invention comprises more than 6%, such as more than 7, 8, 9, 10,11,12,13, 13, 14,15, 16,17, 18, 19, 20, 21, 22, 23, 24, 25, 26, 27, 28, 29, 30, 31, 32, 33, 34, 35, 36, 37, 38, 39, 40% resistant starch. Thus, the invention in this embodiment provides a par-fried potato product which has beneficial effects in that it contains more resistant starch than the previously known par-fried potato products.

In one embodiment the potato product consists of industrially pre-cooked potatoes (pre-boiled potatoes). Preferably the industrially pre-cooked potato product produced according to the invention comprises more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch. Thus, the invention in this embodiment provides an industrially pre-cooked potato product which has beneficial effects in that it contains more resistant starch than the previously known industrially pre-cooked potato products.

Extruded potato snacks, cooled mashed potatoes, instant mashed potatoes, croquettes and nuggets may also be produced using conventional techniques known to the skilled person from potato granules, potato flakes or ground or crushed dehydrated potato dice and slice pieces produced according to the invention.

Accordingly, in one embodiment the potato product consists of extruded potato snacks. Preferably the extruded potato snack product produced according to the invention comprises more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch. Thus, the invention in this embodiment provides an extruded potato snack product which has beneficial effects in that it contains more resistant starch than the previously known extruded potato snack products.

In one embodiment the potato product consists of potato croquettes. Preferably the potato croquettes product produced according to the invention comprises more than 6%, such as more than 7, 8,9, 10, 11,12,13, 13, 14, 15,16, 17, 18, 19, 20, 21, 22, 23, 24, 25, 26, 27, 28, 29, 30, 31, 32, 33, 34, 35, 36, 37, 38, 39, 40% resistant starch. Thus, the invention in this embodiment provides a potato croquettes product which has beneficial effects in that it contains more resistant starch than the previously known potato croquettes products.

In one embodiment the potato product consists of potato nuggets. Preferably the potato nugget product produced according to the invention comprises more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch. Thus, the invention in this embodiment provides a potato nugget product which has beneficial effects in that it contains more resistant starch than the previously known potato nugget products.

In one embodiment the potato product consists of mashed potatoes, such as cooled mashed potatoes or instant mashed potatoes. Preferably the mashed potato product produced according to the invention comprises more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch. Thus, the invention in this embodiment provides a mashed potato product which has beneficial effects in that it contains more resistant starch than the previously known mashed potato products.

Potato pre-products for use in the present invention are preferably processed according to the invention “in situ” by processing potatoes enzymatically as an integrated part of the industrial processing of the potatoes or the potato pre-products into potato products according to the present invention.

Preferably, the potato pre-products are treated in order to disrupt or destroy the cell membranes of intact potato cells prior to enzymatic treatment. This may be done e.g. by heat treatment of above 50 to 60° C. Such heat treatment may e.g. be accomplished when steam-peeling the potato pre-products. The treatment in order to disrupt or destroy the cell membrane of intact potato cells prior to enzymatic treatment may also be accomplished as part of the heating process wherein the potato pre-products are heated to the temperature at which the enzymatic treatment according to the invention is to occur.

The potato pre-products may additionally be pre-treated in various ways such as e.g. washing, cooking, blanching or steaming.

Thus, in a preferred embodiment of the invention the potato product is produced from potato pre-products using conventional methods in combination with enzymatic treatment according to the invention “in situ”. Thereby, process time may be optimised and an increased yield and efficiency may be achieved.

Conventional methods for producing potato products are known to the skilled person. For production of flakes and granules reference is made to “Potato Processing”, Ed. Talburt, W. F. & Smith, O.; Van Nostrand Reinhold, New York (1987). In particular reference is made to chapter 12 (granules) and chapter 13 (flakes). Potato flakes are dehydrated potato mash dried in a thin layer by e.g. drum drying. The dried sheet is broken mechanically, which results in cell rupture (15-20%). Flakes are generally soluble in cold water. Granules are air dried and generally soluble in warm water.

The potato product produced according to the invention may subsequently be used directly for consumption (i.e. optionally after further processing such as after further cooking) or it may be further processed (e.g. dehydrated and/or extruded as well as blanched, cooked, fried etc.) to produce other types of potato products e.g. chips, fabricated chips or french fries.

The enzymatic treatment according to the invention is preferably accomplished using an enzyme selected from the group of enzymes capable of debranching starch. In one embodiment, a combination of different debranching enzymes is used.

Preferred enzymes in the context of the present invention are amylo-alpha-1,6-glucosidase, limit dextrinase, pullulanase and isoamylase. More than one type of debranching enzyme may be used in a method of the invention, e.g. pullulanase combined with isoamylase, amylo-alpha-1,6-glucosidase or limit dextrinase, or isoamylase combined with amylo-alpha-1,6-glucosidase or limit dextrinase. Also, more than one enzyme of the same type of debranching enzyme may be used in a method of the invention, e.g. two different pullulanases or two different isoamylases.

Particularly preferred enzymes in the context of the present invention are pullulanase and isoamylase.

Isoamylase has been shown to be especially suitable in increasing the content of resistant starch in the products produced according to the invention. Accordingly, in one embodiment the most preferred enzyme in the context of the present invention is an isoamylase.

The isoamylase may be of any origin, e.g. of microbial origin, e.g. from filamentous fungi, yeast or bacteria. It may be derivable from a strain of e.g. Rhodothermus, Sulfolobus, Streptomyces, Flavobacterium, Cytophaga, Pseudomonas, such as Pseudomonas amyloderamosa, Xanthomonas, such as Xanthomonas maltophilia, Lipomyces, such as Lipomyces kononenkoae, or Bacillus, such as Bacillus circulans.

Pullulanase has been shown to be especially suitable in increasing the content of resistant starch in the products produced according to the invention. Further, pullulanase is well suited to operate at certain condition e.g. at pH values typically applied during potato processing or at temperatures above swelling or gelatinization temperatures of potato starch. Accordingly, in one embodiment the most preferred enzyme in the context of the present invention is a pullulanase.

The pullulanase may be of any origin, e.g. of microbial origin, e.g. from filamentous fungi, yeast or bacteria. It may be derivable from a strain of e.g. Bacillus, such as Bacillus deramificans, Bacillus acidopullulyticus, Bacillus circulans, Bacillus sectorramus, Bacillus brevis, Bacillus amyloderamificans or Bacillus naganoensis, or Klebsiella, such as Klebsiella planticola or Klebsiella pneumoniae. Commercially available pullulanase preparations which may be used include Promozyme D2 and Promozyme 400 L (available from Novozymes A/S), G-zyme and Optimax-L 300 (available from Genencor Int.), Kleistase PL 45 (available from Daiwa Kasei), Pulluzyme 750 L (available from Rhodia) and Amano 3 and Amano 8 (available from Amano).

In a preferred embodiment the enzyme used for the enzymatic treatment according to the invention is a pullulanase comprising an amino acid sequence which has at least 70% identity with SEQ ID NO:1 or a fragment thereof.

In a highly preferred embodiment the enzyme used for the enzymatic treatment according to the invention is a pullulanase comprising an amino acid sequence which has at least 80% identity with SEQ ID NO:1 or a fragment thereof.

In a highly preferred embodiment the enzyme used for the enzymatic treatment according to the invention is a pullulanase comprising an amino acid sequence which has at least 90% identity with SEQ ID NO:1 or a fragment thereof.

In a highly preferred embodiment the enzyme used for the enzymatic treatment according to the invention is a pullulanase comprising the amino acid sequence of SEQ ID NO:1 or a fragment thereof.

Another preferred debranching enzyme to be used in the method of the present invention is a hybrid polypeptide comprising a catalytic starch debranching domain and a starch binding domain and optionally a linker sequence connecting said domains.

The catalytic starch debranching domain may in principle be any such domain capable of catalysing the debranching of starch. The catalytic starch debranching domain is preferably derived from a pullulanase, more preferably from a pullulanase from Bacillus acidopullulyticus.

The starch binding domain (SBD) may in principle be any protein domain capable of binding to starch.

The SBD may belong to a recognized group of carbohydrate binding modules, or it may have a unique structure not being similar to other known carbohydrate binding modules. Several carbohydrate binding modules (CBM's) have been described in the literature and grouped in families based on sequence and structural similarities. Starch binding domains are found in the carbohydrate binding domain families CBM-20, CBM-21, CBM-25, CBM-26, CBM-34, CBM-41 and CBM-45. It is preferred that the SBD according to the invention belongs to the CBM-20 family.

SBD's belonging to the CBM-20 family have been found in enzymes derived from archae bacteria such as in the PF1108 protein from Pyrococcus furiosis DSM3638 (Uniprot acc. No. Q8U1U7); from eubacteria such as in the alpha-amylase protein derived from Anoxybacillus contaminans (previously known as Bacillus flavothermus), the alpha-amylase from Bacillus licheniformis and the alpha-amylase from Bacillus circulans AM7; and from eukaryotes such as in the glucoamylase from Aspergillus niger.

The SBD may be a natural SBD or it may be a variant of a natural SBD having starch binding activity. In this connection a variant is understood as a polypeptide differing from a natural polypeptide by at least one amino acid residue. The at least one differing amino acid may be selected among substitutions, insertion or deletions of one or more amino acid residue or any combination thereof. Methods for preparing variant of a protein such as a SBD are well known to the skilled person.

An important purpose of the linker sequence is separating the catalytic domain from the SBD in order to prevent any steric hindrance of the function of one domain of the hybrid by another part of the hybrid. The linker may consist of only one or a few amino acids resulting of the construction strategy of the hybrid, or the linker may be a longer peptide. The exact sequence of the linker is not critical, however it is preferred that the sequence of the linker is selected so that the linker does not adopt any rigid structure. The amino acid composition of the linker is preferably selected so that the linker is rich in hydrophilic residues. Further proline residues may be beneficial since they have the ability to disrupt any secondary structure of the linker.

A preferred example of a proline rich linker according to the invention is -PEPTPEPN-.

In a particular preferred embodiment, a hybrid polypeptide to be used in the method of the present invention comprises an amino acid sequence which has at least 70% identity, preferably at least 80%, at least 90%, at least 95% or at least 98%, with SEQ ID NO: 2.

The amount of enzyme used is dependent upon the enzyme source and activity and base material used. Typically, the enzyme is used in a concentration of between 1 microgram enzyme protein (EP) per ml suspension and 700 microgram EP per ml suspension. Preferably the enzyme is used in a concentration of between 10 and 500 microgram EP per ml suspension, more preferably between 10 and 300 microgram EP per ml suspension. Suspension, in this context, means the aqueous composition comprising the potato pre-product.

The optimum parameters for enzymatic activity will vary depending upon the enzyme used. The rate of enzyme degradation depends upon factors known in the art, including the enzyme concentration, substrate concentration, pH, temperature, the presence or absence of inhibitors, and the degree and type of modification of the enzyme if any. These parameters may be adjusted to optimize the digestion rate of the starch base.

Generally the method of the invention is performed in an aqueous or buffered slurry or suspension comprising the potato pre-product to be treated. Typically, enzyme digestion is carried out at the highest solids content feasible without reducing reaction rates in order to facilitate any desired subsequent drying of the potato products. Reaction rates may be reduced by high solids content as agitation becomes difficult or ineffective and the potato pre-product becomes more difficult to handle. The concentration of the potato pre-product in the suspended compositions may generally vary and be in the range of about 5 to about 40% w/w, such as 6, 7, 8, 9, 10, 11, 12, 13,13, 14, 15, 16, 17, 18, 19, 20, 21, 22, 23, 24, 25, 26, 27, 28, 29, 30, 31, 32, 33, 34, 35, 36, 37, 38, 39, 40% w/w.

Before or during the enzymatic treatment step, the temperature of the aqueous composition comprising the potato pre-product should be adjusted to provide effective enzymatic reaction. The skilled person will know which temperature or temperature range will be suitable for the enzymatic treatment in the given industrial process and should therefore be chosen to obtain sufficient or optimal enzymatic reaction. Such temperature will both depend on the specific industrial process and the debranching enzyme to be used. In general, a temperature of about 25° C. to about 80° C. will be suitable, particularly from about 50° C. to about 70° C.

Likewise, the pH of the aqueous composition comprising the potato pre-product may be adjusted before or during the enzymatic treatment. The skilled person will know at which pH the enzymatic reaction in the given industrial process will be sufficient or optimal. In general, the pH may be adjusted to between about 3.0 and about 7.0, particularly from about 3.5 to about 6.5, using techniques known in the art.

The enzyme reaction is continued until the desired amount of starch is debranched in the potato pre-products. In general, the period of time sufficient for debranching the starch in the potato pre-products (incubation time) is from about 5 minutes to about 20 hours, preferably about 10 minutes to about 3 hours, more preferably about 10 minutes to about 1 hours, even more preferably about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 minutes. The time of the reaction is dependent upon the type of potato pre-product (particularly, the surface to volume ratio of the potato pre-product), the type and amount of enzyme used, and the reaction parameters of solids percent, pH, and temperature.

In one embodiment, the aqueous composition comprising the potato pre-product may be, e.g., sliced or cut potatoes which have optionally been blanched, cooked or washed, and which are subsequently treated with one or more debranching enzymes by dipping the potato pre-product in a solution comprising the enzyme(s) for a short time period, such as for 5 to 120 seconds, and subsequent incubation in air. The invention therefore in one embodiment relates to a method for increasing the content of resistant starch in a potato product said method comprising the steps of:
a. providing an aqueous composition comprising a potato pre-product,
b. adjusting the temperature of the composition of step a) to a temperature suitable for enzymatic treatment of the potato pre-product by debranching enzymes,
c. treating the potato pre-product with one or more debranching enzymes, and
d. holding the enzyme treated potato pre-product at a temperature of between −2 and 50° C.

Inactivation of the enzyme used according to the present invention will normally occur as a consequence of the treatment steps used to obtain a potato product according to the invention. Optionally, the enzyme may however be deactivated (denatured) by any technique known in the art such as heat, acid or base deactivation. For example, acid deactivation may be accomplished by adjusting the pH to lower than 2.5 for at least 30 minutes or heat deactivation may be accomplished by raising the temperature to from about 80 to about 90° C. for at least about 5 minutes to fully deactivate the enzyme.

After enzymatic treatment the potato pre-product is optionally cooled to a lower temperature.

The enzyme treated potato pre-product is allowed to stand whereby the starch in the debranched potato pre-product is allowed to crystallize and retrograde. The standing or holding of the enzyme treated potato pre-product is continued until the desired amount of crystallization and retrogradation is obtained (holding time). In general, the period of time sufficient for crystallisation and retrogradation of the enzyme treated potato pre-product is from about 10 minutes to about 40 hours. Thus, the enzyme treated potato pre-product is preferably held at −2 to 50° C. for about 10 minutes to about 40 hours, more preferably for about 10 minutes to about 20 hours, such as for about 10 minutes to about 4 hours, or for about 15 minutes to about 2 hours, even more preferably for about 15 minutes to about 1 hour.

The potato product may then be recovered using methods known in the art, particularly by filtration or by drying, including spray drying, freeze drying, flash drying or air drying. It has been shown that an additional increase in the content of resistant starch in the potato product produced according to the invention can be obtained by a subsequent treatment step wherein the potato pre-product is heated after the enzymatic treatment. Optionally, the enzyme treated potato pre-product may be cooled to a temperature of between −2 and 30° C. prior to such heating. Thus, in one embodiment the enzyme treated potato pre-products are cooled and additionally subjected to a second heating step. Preferably, the products are heated to a temperature of between 50 and 90° C. in the second heating step, more preferable 60 to 80° C., even more preferably 65 to 75° C. The additional heating step may have a duration of between 5 and 40 minutes, preferably between 10 and 30 minutes, even more preferably between 15 and 25 minutes. Preferably, the optional cooling and subsequent heating is performed before holding of the enzyme treated potato pre-product at a temperature of between −2 and 50° C. to obtain further retrogradation.

Additional cycles of cooling to temperatures between −2 and 30° C. followed by heating to temperatures between 50 and 90° C. may be applied to further increase the content of resistant starch.

It has further been shown that an additional increase in the content of resistant starch in the potato product produced according to the invention can be obtained by a subsequent treatment step wherein the enzyme treated potato pre-product is frozen. Thus, in one embodiment enzyme treated potato pre-product is additionally treated in a freezing step. Preferably, the additional freezing step is an instant freezing step, whereby the pre-product is frozen in less than 5 minutes. In one embodiment the enzyme treated potato pre-product is frozen by blowing air having a temperature of −60° C. to −10° C. over the products.

It has been shown that an additional increase in the content of resistant starch in the potato product produced according to the invention can be obtained by a subsequent treatment step wherein the enzyme treated potato pre-product is dried. Thus, in one embodiment the enzyme treated potato pre-product is additionally treated in a drying step.

It has been shown that an additional increase in the content of resistant starch in the potato product produced according to the invention can be obtained by a subsequent treatment step wherein the enzyme treated potato pre-product is freeze-dried. Thus, in one embodiment the enzyme treated potato pre-product is additionally treated in a freeze-drying step.

In another embodiment, the additional step of drying the enzyme treated potato pre-product is performed before step d) and step d) is carried out on a reconstituted dried enzyme treated potato pre-product, i.e. on a dried enzyme treated potato pre-product which has been reconstituted by addition of water. The reconstituted potato product may form part of a dough to be used for further production.

In another embodiment, the enzyme treated potato pre-product is semi-dried, e.g. partially dried to a dry matter content of no more than 80%, preferably no more than 70%, no more than 60% or no more than 50%, resulting in a partially dried enzyme-treated potato pre-product. In one embodiment, partial drying is performed before step d) and step d) is carried out on the partially dried enzyme-treated potato pre-product, e.g., retrogradation may take place during holding of the enzyme treated potato pre-product at a temperature of between −2 and 50° C.

In another embodiment, a small amount of already retrograded starch is added to the enzyme treated potato pre-product before or during step d). Such addition of already retrograded starch may seed retrogradation of the enzymatically debranched starch in the enzyme treated potato pre-product.

Dependent on the type of potato product to be produced the skilled person may employ other treatment steps. Such steps may be performed after the treatment steps according to the invention, or they may be employed in between the treatment steps according to the invention. Examples of other treatment steps include mechanical treatment steps like cutting, mashing, molding and pressing. Other examples of treatment steps include treatment steps like frying, deep-frying, par-frying, cooking, bleaching, baking and leaching the potato product.

### EMBODIMENTS

In one embodiment according to the invention, French fries may be produced in an industrial scale (e.g. 0.5 to 30 ton/hour) in e.g. the following way: Potatoes are washed and peeled (e.g. steam peeling or knife peeling or abrasive peeling). The resulting potato pre-products are cut into the desired shape (e.g. elongated potato sticks). The cut potato pre-products are blanched or leached at 60° C. to 90° C. for 5 to 60 minutes typically in two or three sequential steps. The temperature of the blanched potato pre-products are then adjusted to the temperature suitable for enzymatic treatment according to the invention (e.g. 45° C. to 75° C.) and thereafter treated with enzyme according to the invention. The incubation time may be 5 to 120 minutes, preferably between 10 and 20 minutes. The treatment with debranching enzyme may be integrated with any of the preceding blanching or leaching steps. The resulting products may thereafter be dried (e.g. by air) and further cooled to between −2 and 50° C., such as to between −2 and 30° C., and held at that temperature according to the invention for 0.5 to 4 hours. The resulting product is pre-cooked e.g. by deep-frying at 150 to 200° C. for 30 to 180 seconds (to reach a moisture content of about 60 to 75%). The products are thereafter cooled. The holding of the enzyme treated potato pre-product at a temperature of between −2 and 50° C. according to the invention may optionally be performed after pre-cooking instead of prior to pre-cooking. The product is optionally frozen or packed in modified atmosphere. The french fries produced according to the invention may comprise between 4% and 60% resistant starch. Preferably the french fries produced according to the invention comprise more than 5% resistant starch. Preferably the french fries produced according to the invention comprise more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch.

In one embodiment according to the invention, potato flakes may be produced in an industrial scale in e.g. the following way: Potatoes are rinsed (washed) and peeled. The resulting potato pre-products are sliced into thin potato pre-products (thickness of between 1 and 2 cm). The potato pre-products are then pre-cooked for about 20 min at 70 to 75° C. The products are then cooled for about 20 min (target pulp temperature depends on dry solids content—for high density potatoes the target pulp temperature is 21° C.—for low density potatoes the target pulp temperature is 10° C.). One result of this precooking step is that starch gelatinizes within the cells. Some resistant starch may additionally be formed during the cooling step. The products are subsequently cooked at a temperature of 90° C. to 110° C. for 20 to 60 minutes (usually 30 minutes), e.g. by using direct steam. While still hot the products are subsequently mashed. The mash is then cooled to the temperature suitable for enzymatic treatment according to the invention (45° C. to 75° C.) and thereafter treated with enzyme according to the invention. The incubation time may be 5 to 120 minutes, preferably between 15 and 20 minutes. The products are thereafter cooled to between −2 and 50° C., such as to between −2 and 30° C., and held at that temperature according to the invention for 0.5 to 4 hours. The products are then dried and the dried sheets are broken. The potato flakes produced according to the invention may comprise between 4% and 60% resistant starch. Preferably the potato flakes produced according to the invention comprise more than 5% resistant starch. Preferably, the potato flake product produced according to the invention comprise more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch.

In one embodiment, potato flakes are produced essentially as described above, except that the mash after enzymatic treatment is not cooled and held in the cold, but instead partially dried to a dry matter content of no more than 80% resulting in partially dried sheets, which are broken into flakes. Retrogradation of the partially dried flakes will take place during holding of the flakes at a temperature of between −2 and 50° C. according to the invention.

In one embodiment according to the invention, potato flakes may be produced in an industrial scale in e.g. the following way: Potatoes are rinsed (washed) and peeled. The resulting potato pre-products are sliced into thin potato pre-products (thickness of between 1 and 2 cm). The potato pre-products are then pre-cooked for about 20 min at 70 to 75° C. The products are then cooled to a temperature suitable for enzymatic treatment according to the invention (45° C. to 75° C.) and thereafter treated with enzyme according to the invention. The incubation time may be 5 to 120 minutes, preferably between 15 and 20 minutes. The enzyme treatment may also be performed simultaneously with precooking. The products are thereafter cooled to between −2 and 50° C., such as to between −2 and 30° C., and held at such temperature according to the invention for 0.5 to 4 hours. The products are subsequently cooked at a temperature of 90° C. to 110° C. for 20 to 60 minutes (usually 30 minutes), e.g. by using direct steam. While still hot the products are subsequently mashed. The products are then dried and the sheets are broken. The potato flakes produced according to the invention comprise between 4% and 60% resistant starch. Preferably the potato flakes produced according to the invention comprise more than 5% resistant starch. More preferably, the potato flake product produced according to the invention comprise more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch.

In one embodiment, potato flakes are produced essentially as described above, except that the sliced potatoes after precooking and enzymatic treatment are not cooled and held in the cold, but instead cooked and mashed, whereafter the mash is partially dried to a dry matter content of no more than 80%, resulting in partially dried sheets, which are broken into flakes. Retrogradation of the partially dried flakes will take place during holding of the flakes at a temperature of between −2 and 50° C. according to the invention.

In one embodiment according to the invention, potato flakes may be produced in an industrial scale in e.g. the following way: Potatoes are rinsed (washed) and peeled. The resulting potato pre-products are sliced into thin potato pre-products (thickness of between 1 and 2 cm). The products are then heated to the temperature suitable for enzymatic treatment according to the invention (45° C. to 75° C.) and thereafter treated with enzyme according to the invention. The incubation time may be 5 to 120 minutes, preferably between 15 and 20 minutes. The products are thereafter cooled to between −2 and 50° C., such as to between −2 and 30° C., and held at that temperature according to the invention for 0.5 to 4 hours. The products may optionally then be pre-cooked for about 20 minutes at around 70 to 75° C. The products are then optionally cooled for about 20 min (target pulp temperature depends on dry solids content—for high density potatoes the target pulp temperature is 21° C.—for low density potatoes the target pulp temperature is 10° C.). The products are subsequently cooked at a temperature of 90° C. to 110° C. for 20 to 60 minutes (usually 30 minutes), e.g. by using direct steam. While still hot the products are subsequently mashed. The products are then dried and the sheets are broken. The potato flakes produced according to the invention comprise between 4% and 60% resistant starch. Preferably the potato flakes produced according to the invention comprise more than 5% resistant starch. More preferably, the potato flake product produced according to the invention comprise more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch.

In one embodiment, potato flakes are produced essentially as described above, except that the sliced potatoes after enzymatic treatment are not cooled and held in the cold, but instead cooked and mashed, whereafter the mash is partially dried to a dry matter content of no more than 80%, resulting in partially dried sheets, which are broken into flakes. Retrogradation of the partially dried flakes will take place during holding of the flakes at a temperature of between −2 and 50° C. according to the invention.

In one embodiment according to the invention, industrially pre-cooked potatoes (pre-boiled potatoes) may be produced in an industrial scale in e.g. the following way: Potatoes are rinsed (washed) and peeled. Peeling may generally be done by steam peeling at e.g. 150° C. or by knife peeling. The resulting potato pre-products are optionally sliced, cut and/or sorted into potato pre-products of the desired shape and size. The products are then heated to the temperature suitable for enzymatic treatment according to the invention (45° C. to 75° C.) and thereafter treated with enzyme according to the invention. The incubation time may be 5 to 120 minutes, preferably between 15 and 20 minutes. The products may optionally then be washed and/or salted. The enzyme treatment may also be performed simultaneously with slicing or cutting, before sorting and/or simultaneously with or after washing and salting. The products are subsequently cooked at a temperature of 70° C. to 110° C. for 10 to 120 minutes (usually 30 minutes). Steam cooking may be applicable (e.g. at 100 to 150° C.) by using direct steam, particularly if atmospheric packaging is performed after cooking. Packaging may be in vacuum or modified atmosphere and may be performed before or after cooking. If the products are packaged after cooking, addition of preservatives may be needed. The products are thereafter cooled to between −2 and 50° C., such as to between −2 and 30° C., and held at that temperature according to the invention for at least 0.5 to 4 hours. This treatment step may be performed as part of the storage of the products and may be performed while or after the products are packaged. In practice, the pre-cooked potatoes may be stored for several weeks at e.g. about 4° C. and are typically pre-heated before serving. The industrially pre-cooked potatoes (pre-boiled potatoes) produced according to the invention comprise between 10% and 60% resistant starch. Preferably the industrially pre-cooked potatoes produced according to the invention comprise more than 15% resistant starch. More preferably, the industrially pre-cooked potatoes produced according to the invention comprise more than 16%, such as more than 17, 18, 19, 20, 21, 22, 23, 24, 25, 26, 27, 28, 29, 30, 31, 32, 33, 34, 35, 36, 37, 38, 39, 40% resistant starch.

In one embodiment according to the invention, sliced potato chips may be produced in an industrial scale in e.g. the following way: Potatoes are rinsed (washed) and peeled. Peeling may generally be done by abrasive peeling, by knife peeling or by steam peeling at e.g. 150° C. The resulting potato pre-products are optionally sliced and cut and/or sorted into potato pre-products of the desired shape and size. The sliced or cut product may optionally be blanched (e.g. for 10 sec. to 10 min. at 65 to 95° C. Blanching time and temperatures depends on potato variety and storage). The sliced and/or cut and/or blanched product may optionally be washed. The products are then heated to the temperature suitable for enzymatic treatment according to the invention (45° C. to 75° C.) and thereafter treated with enzyme according to the invention. The incubation time may be 5 to 120 minutes, preferably between 15 and 20 minutes. The products are thereafter cooled to between −2 and 50° C., such as to between −2 and 30° C., and held at that temperature according to the invention for at least 0.5 to 4 hours. Optionally, the products may be treated by additional heating to 50 to 75° C. for 5 to 30 min. The products may subsequently optionally be sorted and dewatered. The products are thereafter deep fried for 10 sec. to 8 minutes at 120 to 195° C. Frying times and temperatures depends on cut size, product type etc. The oil may subsequently be stripped and the products may be flavored and packaged. The sequence of treatment with debranching enzyme, cooling and optional heating is preferable performed after slicing and before frying, and may be integrated with any of the existing steps (e.g. simultaneous blanching and enzyme treatment). The debranching enzyme treatment bath may be replaced with a short dip (5 to 120 sec) in the enzyme solution and subsequent incubation in air. The sliced potato chips produced according to the invention may comprise between 4% and 60% resistant starch. Preferably the sliced potato chips produced according to the invention comprise more than 5% resistant starch. More preferably the sliced potato chips produced according to the invention comprise more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch.

In one embodiment according to the invention, ground or crushed dehydrated potato dice and slice pieces may be produced in an industrial scale in e.g. the following way: Potatoes are rinsed (washed) and peeled. The resulting potato pre-products are cut into potato pieces by slicing or dicing. The potato pieces are then blanched for 10 sec to 30 min at 60 to 95° C. or by steaming. The temperature of the potato pieces are adjusted to the temperature suitable for enzymatic treatment according to the invention (30° C. to 75° C., preferably 45 to 75° C., more preferably 45 to 65° C.) and thereafter treated with enzyme according to the invention. The potato pieces may be submerged in or sprinkled by water containing the enzyme according to the invention. The incubation time may be 5 to 120 minutes, preferably between 10 and 20 minutes. The products are thereafter cooled to between −2 and 50° C., preferably between −2 and 10° C., and held at that temperature according to the invention for 0.2 to 4 hours. The potato pieces may optionally then be heated for about 5 to 30 minutes at around 60 to 90° C., preferably 60 to 80° C. The potato pieces are then dried, e.g. in hot air to a moisture content of 1 to 10%, preferably 6 to 8%. The dried potato pieces may further be ground. The ground or crushed dehydrated potato dice and slice pieces produced according to the invention comprise between 4% and 60% resistant starch. Preferably the ground or crushed dehydrated potato dice and slice pieces produced according to the invention comprise more than 5% resistant starch. More preferably, the ground or crushed dehydrated potato dice and slice pieces produced according to the invention comprise more than 6%, such as more than 7, 8, 9, 10, 11, 12, 13, 13, 14, 15, 16, 17, 18, 19, 20, 21, 22, 23, 24, 25, 26, 27, 28, 29, 30, 31, 32, 33, 34, 35, 36, 37, 38, 39, 40% resistant starch.

### EXAMPLES

### Example 1

8-10 g potato flakes (dry solids 91.4%) were grinded in a coffee mill for 1 min. 5.00 g of milled flakes were suspended in 100 ml 25 mM acetate buffer pH 5.0. The suspension was stirred for 30 min at room temperature (magnetic stirring). 1.1 g of this suspension was transferred to eppendorf tubes. Isoamylase (1000 U/ml from Pseudomonas sp., Megazyme, Lot 51203) was tested in four different concentrations: 0 U/ml isoamylase (41 μl de-ionized water); 3 U/ml isoamylase (41 μl of isoamylase diluted 12.42 times in de-ionized water), 10 U/ml Isoamylase (41 μl of isoamylase diluted 3.73 times in de-ionized water) and 30 U/ml Isoamylase (41 μl of isoamylase diluted 1.24 times in de-ionized water). All tests were prepared in double determinations. After enzyme addition, the suspensions were mixed and incubated for 2 hours at 55° C. on an Eppendorf Thermomixer Comfort (1000 rpm). The enzyme reaction was terminated by increasing the temperature to 90° C. for 10 min. The samples were thereafter held (holding time) at 4° C. for 1 or 4 hours (according to below table) in order to facilitate the formation of resistant starch. After the cold holding time the samples were analysed for resistant starch using Megazyme Resistant Starch Assay Procedure K-RSTAR 08/05 (AOAC Method 2002.02 and AACC Method 32-40). The total content of the eppendorf tubes (1.14 g) was used for the analysis (not 0.5 g as stated in the above assay procedure (for wet samples)). The results are given below:

| | Resistant starch | Resistant starch |
|---|---|---|
| Dose of | (g/100 g flakes) | (g/100 g flakes) |
| Isoamylase | 1 hour holding time | 4 hour holding time |
| 0 U/ml | 1.43 | 0.97 |
| 3 U/ml | 2.28 | 3.36 |
| 10 U/ml | 1.57 | 3.82 |
| 30 U/ml | 4.47 | 13.3 |

Additionally, the unprocessed potato flake powder was analysed using the Megazyme resistant starch method resulting in 1.87 g resistant starch/100 g flakes.

The results show that it is possible to increase the level of resistant starch in potato products using the described method “in situ”. The example further show that increasing holding time at 4° C. and/or increasing dose of Isoamylase results in significant increase in the level of resistant starch.

### Example 2

8-10 g potato flakes (dry solids 91.4%) were grinded in a coffee mill for 1 min. 5.00 g of milled flakes were suspended in 100 ml 25 mM acetate buffer pH 5.0. The suspension was stirred for 30 min at room temperature (magnetic stirring). 1.1 g of this suspension was transferred to eppendorf tubes. Isoamylase (1000 U/ml from Pseudomonas sp., Megazyme, Lot 51203) was tested in four different concentrations: 0 U/ml isoamylase (41 μl de-ionized water); 3 U/ml isoamylase (41 μl of isoamylase diluted 12.42 times in de-ionized water), 10 U/ml Isoamylase (41 μl of isoamylase diluted 3.73 times in de-ionized water) and 30 U/ml Isoamylase (41 μl of isoamylase diluted 1.24 times in de-ionized water). All tests were prepared in double determinations. After enzyme addition, the suspensions were mixed and incubated for 2 hours at 55° C. on an Eppendorf Thermomixer Comfort (1000 rpm). The enzyme reaction was terminated by increasing the temperature to 90° C. for 10 min. The samples were thereafter held (holding time) at 4° C. for 4 hours in order to facilitate the formation of resistant starch. After the holding time the samples were quickly frozen at −40° C. (using shock freezing in Tecnomac). The frozen samples were thereafter freeze dried for 2 days in Heto Power Dry PL9000 from Holm & Halby. After freeze drying the samples were analysed for resistant starch using Megazyme Resistant Starch Assay Procedure K-RSTAR 08/05 (AOAC Method 2002.02 and AACC Method 32-40). The results are given below:

| | Resistant starch |
|---|---|
| Dose of Isoamylase | (g/100 g flakes) |
| 0 U/ml | 2.07 |
| 3 U/ml | 5.97 |
| 10 U/ml | 7.77 |
| 30 U/ml | 18.2 |

Comparing the results of example 2 with the results of example 1 (4 hours holding time) it is evident that freezing and freeze drying result in a significant increase in the level of resistant starch in the potato flakes.

### Example 3

8-10 g potato flakes (dry solids 91.4%) were grinded in a coffee mill for 1 min. 5.00 g of milled flakes were suspended in 100 ml 25 mM acetate buffer pH 5.0. The suspension was stirred for 30 min at room temperature (magnetic stirring). 1.1 g of this suspension was transferred to eppendorf tubes. Promozyme D2 (1350 NPUN/g, Novozymes A/S) was tested in four different concentrations: 0 NPUN/ml Promozyme D2 (41 μl de-ionized water); 0.5 NPUN/ml Promozyme D2 (41 μl of Promozyme D2 diluted 100 times in de-ionized water); 5 NPUN/ml Promozyme D2 (41 μl of Promozyme D2 diluted 10 times in de-ionized water); 50 NPUN/ml Promozyme D2 (41 μl of Promozyme D2). All tests were prepared in double determinations. After enzyme addition, the suspensions were mixed and incubated for 2 hours at 55° C. on an Eppendorf Thermomixer Comfort (1000 rpm). The enzyme reaction was terminated by increasing the temperature to 90° C. for 10 min. The samples were thereafter held (holding time) at 4° C. for 4 hours in order to facilitate the formation of resistant starch. After the holding time the samples were quickly frozen at −40° C. (using shock freezing in Tecnomac). The frozen samples were thereafter freeze dried for 2 days in Heto Power Dry PL9000 from Holm & Halby. After freeze drying the samples were analysed for resistant starch using Megazyme Resistant Starch Assay Procedure K-RSTAR 08/05 (AOAC Method 2002.02 and AACC Method 32-40). The results are given below:

| Dose of Promozyme | Resistant starch |
|---|---|
| D2 | (g/100 g flakes) |
| 0 NPUN/ml | 2.30 |
| 0.5 NPUN/ml | 2.57 |
| 5 NPUN/ml | 5.78 |
| 50 NPUN/ml | 14.9 |

The results show that increasing dose levels of Promozyme D2 results in a concomitant increase of resistant starch.

### Example 4

8-10 g potato flakes (dry solids 91.4%) were grinded in a coffee mill for 1 min. 5.00 9 of milled flakes were suspended in 100 ml 25 mM acetate buffer pH 5.0. The suspension was stirred for 30 min at room temperature (magnetic stirring). To each eppendorf tube was transferred 1.1 g of this suspension. Isoamylase (1000 U/ml from Pseudomonas sp., Megazyme, Lot 51203) was tested in three different concentrations: 0 U/ml isoamylase (41 μl de-ionized water); 10 U/ml Isoamylase (41 μl of isoamylase diluted 3.73 times in de-ionized water) and 30 U/ml Isoamylase (41 μl of isoamylase diluted 1.24 times in de-ionized water). All tests were prepared in double determinations. After enzyme addition then the solutions were mixed and incubated for 0.5, 2 and 22 hours at 55° C. on an Eppendorf Thermomixer Comfort (1000 rpm) according to the table below. The enzyme reaction was terminated by placing the tubes in an Eppendorf Thermomixer Comfort (1000 rpm) for 10 min at 90° C. The samples were held (holding time) at 4° C. for 4 hours in order to facilitate the formation of resistant starch. After the holding time then the samples were quickly frozen at −40° C. (using shock freezing in Tecnomac). The frozen samples were freeze dried for 2 days in Heto Power Dry PL9000 from Holm & Halby. After freeze drying the samples were analysed for resistant starch using Megazyme Resistant Starch Assay Procedure K-RSTAR 08/05 (AOAC Method 2002.02 and AACC Method 3240). The results are given below:

| | | Resistant starch |
|---|---|---|
| Dose of Isoamylase | Enzyme Incubation time | (g/100 g flakes) |
| 0 U/ml | 0.5 hours | 1.89 |
| | 2.0 hours | 2.81 |
| | 22 hours | 1.91 |
| 10 U/ml | 0.5 hours | 17.2 |
| | 2.0 hours | 14.0 |
| | 22 hours | 14.7 |
| 30 U/ml | 0.5 hours | 20.5 |
| | 2.0 hours | 20.5 |
| | 22 hours | 17.9 |

0.5 hours enzyme incubation time gives the highest amount of resistant starch (g/100 g flakes) at all dosis levels of Isoamylase.

### Example 5

8-10 g potato flakes (dry solids 91.4%) were grinded in a coffee mill for 1 min. 5.00 g of milled flakes were suspended in 100 ml 25 mM acetate buffer pH 5.0. The suspension was stirred for 30 min at room temperature (magnetic stirring). To each eppendorf tube was transferred 1.1 g of this suspension. Isoamylase (1000 U/ml from Pseudomonas sp., Megazyme, Lot 51203) was tested in 30 U/ml Isoamylase (33 μl of isoamylase). After enzyme addition then the solutions were mixed and incubated for 2 hours at 55° C. on an Eppendorf Thermomixer Comfort (1000 rpm). The enzyme reaction was terminated by placing the tubes in an Eppendorf Thermomixer Comfort (1000 rpm) for 10 min at 90° C. The samples were held (holding time) at 4° C. for 4 hours in order to facilitate the formation of resistant starch. After the holding time a second heat treatment was performed in a water bath at 70° C.; 80° C.; 90° C. or no heat treatment for 20 minutes according to the table below. All tests were prepared in triple determinations. After the second heat treatment then the samples were quickly frozen at −40° C. (using shock freezing in Tecnomac). The frozen samples were freeze dried for 2 days in Heto Power Dry PL9000 from Holm & Halby. After freeze drying the samples were analysed for resistant starch using Megazyme Resistant Starch Assay Procedure K-RSTAR 08/05 (AOAC Method 2002.02 and MCC Method 32-40). The results are given below:

| | Resistant starch |
|---|---|
| Heat treatment | (g/100 g flakes) |
| No heat treatment | 18.1 |
| 70° C. | 27.3 |
| 80° C. | 22.3 |
| 90° C. | 18.0 |

A second heat treatment significantly improves the amount of resistant starch in the flakes.

### Example 6

600 g of Bintje potatoes (Grill-Kartoflen, Interfrugt Catering, Denmark) were manually peeled. Approx. 500 g of the peeled potatoes was steam cooked under pressure using a preheated CertoClav 12 L MultiControl (Tisch-Autoklav, Austria) at 20 psi (125° C.) for 10 min containing 1 l of de-ionized water. The total cooking time was approx. 40 min including heating and cooling time (must be cooled to 99.9° C. before the CertoClav can be opened). The potatoes were transferred to a Stomacher Bag Model 400 (Seward Ltd, UK) and mashed for 4×30 sec using a Bagmixer 400 ml (InterScience, France). The mash was manually shaken to the bottom of the bag between each mash cycle. Four different mash suspensions with varying dry solids content were prepared by mixing the mashed potatoes with de-ionized water according to the following table. The dry solids content was subsequently determined after drying at 105° C.

| Target % dry solids of | g potato | g De-ionized | Actual % dry solids |
|---|---|---|---|
| mash suspension | mash | water added | of mash suspension |
| 20 | 100 | 0 | 19.5 |
| 15 | 100 | 33.3 | 15.3 |
| 10 | 100 | 100 | 9.65 |
| 5 | 100 | 300 | 4.58 |

2.0 g of the mash suspensions were transferred to glass tubes and a magnet was added to each tube.

The tubes containing the mash suspension were pre-heated to 55° C. using a heat block with magnetic stirring. To each tube was further added 250 μl de-ionized water (blank) or enzyme solution according to the table below and incubated for 2.5 hours. The enzyme used was a pullulanase derived from Bacillus acidopullulyticus having the sequence shown in SEQ ID NO: 1. All tests were prepared in double determinations. The enzyme reaction was terminated by placing the tubes in a 90° C. water bath for 10 minutes. The samples were held (holding time) at 4° C. for 4 hours in order to facilitate the formation of resistant starch. After the holding time then the samples were quickly frozen at −40° C. (using shock freezing in Tecnomac). The frozen samples were freeze dried for 2 days in Heto Power Dry PL9000 from Holm & Halby. After freeze drying the samples were analysed for resistant starch using Megazyme Resistant Starch Assay Procedure K-RSTAR 08/05 (AOAC Method 2002.02 and AACC Method 32-40). The results are given below:

| % Dry solids | | | |
|---|---|---|---|
| of mash | | Dose | Resistant starch |
| suspension | Treatment | NPUN(P)/tube | (g/100 g dried mash) |
| 5 | Blank | 0 | 2.70 |
| | SEQ ID NO: 1 | 100 | 10.8 |
| 10 | Blank | 0 | 4.13 |
| | SEQ ID NO: 1 | 100 | 11.9 |
| 15 | Blank | 0 | 4.57 |
| | SEQ ID NO: 1 | 100 | 16.2 |
| 20 | Blank | 0 | 4.28 |
| | SEQ ID NO: 1 | 100 | 15.1 |

The amount of available starch in the blank was measured to 59.0 g/100 dry mash (average of all blank treatments).

Addition of pullulanase significantly increased the level of resistant starch in the potato mash.

### Example 7

Approx. 5000 g Agria Speisekartoffeln (dry matter 21.5%; 15.1% starch) was peeled by abrasion for about 3 minutes using an RWD Schalboy (Reppisch-Werk AG, Switzerland). After peeling the potatoes were cut in 1 cm slices using an Anliker and rinsed in cold tap water (for about 5 minutes in approx. 30 L tap water). The potatoes were blanched for 20 minutes in approx. 30 L of 71° C. tap water, cooled for 20 minutes in 30 L 15-20° C. tap water and finally steam cooked for 35 minutes in 101° C. tap water. The potato pieces were mashed using a Universalküchenmachine (Romca) with 1.5 cm holes, cooled to about 55° C. and blended with enzyme/tap water according to the table below. Two enzyme preparations were used: A pullulanase derived from Bacillus acidopullulyticus having the sequence shown in SEQ ID NO: 1 (1600 NPUN/g) and Promozyme D2 (available from Novozymes, Denmark). The blended mash was transferred to a heating cabinet and incubated for 2 hours (during this time the temperature in the mash drops to about 40° C.). The mash was then cooled to 4° C. for 3 hours to facilitate formation of resistant starch. The cold mash was dried on a single drum drier with two applicator rolls (L. A. Mitchell Ldt., Manchester, UK) at 3 bar steam pressure (140.8° C.). Roller speed as listed in below table. The dried mash was flaked in a Frewitt-Granulator, type MGL.6.A, Freiburg, Switzerland) with a mesh size of 0.5 cm.

A reference sample of potato flakes sample was produced as described above, however, omitting the enzyme incubation and mash cooling step (=standard process).

The potato flakes were analysed for resistant starch using Megazyme Resistant Starch Assay Procedure K-RSTAR 08/05 (AOAC Method 2002.02 and AACC Method 32-40). The dry solids content was determined after drying at 105° C.

| | | | Control | Standard |
|---|---|---|---|---|
| | Promozyme | | (no | process - |
| Parameter | D2 | SEQ ID NO: 1 | enzyme) | reference |
| Net weight of raw | 5004 | 5054 | 5022 | 5012 |
| potatoes (g) | | | | |
| Enzyme addition | 75 g/kg | 35 g/kg mash | — | — |
| | mash | | | |
| Water addition | — | 40 g/kg mash | 75 g/kg | — |
| | | | mash | |
| pH adjustment of | pH 5 by | no | no | no |
| potato mash | addition | | | |
| | of 25 ml 1M | | | |
| | citric acid | | | |
| g flakes produced | 684 | 579 | 756 | 709 |
| Roller speed | 3.5 | 3.5 | 6 | 2.3 |
| (rpm) | | | | |
| Moisture content | 7.83 | 7.69 | 9.31 | 7.17 |
| (%) | | | | |
| Resistant starch | 13.3 | 12.5 | 3.35 | 2.59 |
| (g/100 g DM) | | | | |
| Non resistant | 64.7 | 63.0 | 74.5 | 72.0 |
| starch | | | | |
| (g/100 g DM) | | | | |

When pullulanase was added to the mash a higher content of resistant starch was found in the final flakes.

### Example 8

20 g potato flakes produced as described in Example 7 was grinded in a coffee mill for 30 sec. 10 g of the grinded flakes was mixed for 1 minute with 2.0 g amylopectin using a mini pin mixer from National MFG (Lincoln, Neb.). 8 ml of tap water was added while mixing and the mixing continued for 30 seconds. The dough was gently moulded by hand and sheeted on a noodle forming machine from H. F. Kejenteraan SDN BHD (Malaysia); 3 times×1 mm and 10 times×0.3 mm. 10-12 chips (approx. 2.5 cm) were cut from each dough. The chips were fried for 10 or 30 seconds at 180° C. The potato chips were analysed for resistant starch using Megazyme Resistant Starch Assay Procedure K-RSTAR 08/05 (AOAC Method 2002.02 and AACC Method 32-40). The dry solids content was determined after drying at 105° C. The results are given below:

| | |
|---|---|
| Resistant starch | |
| (g/100 g DM) | Dry solids |

| Sample | 10 sec | 30 sec | 10 sec | 30 sec |
|---|---|---|---|---|
| Promozyme D2 | 7.8 | 7.7 | 89.1 | 91.1 |
| SEQ ID NO: 1 | 9.0 | 6.9 | 87.8 | 94.8 |
| Control | 1.5 | 1.1 | 80.8 | 87.3 |
| (no enzyme) | | | | |
| Standard process - | 1.8 | 1.5 | 77.7 | 83.2 |
| reference | | | | |

Chips prepared from pullulanase treated flakes contain more resistant starch.

### Example 9

8-10 g potato flakes (dry solids 91.4%) were grinded in a coffee mill for 1 min. 5.00 g of milled flakes were suspended in 100 ml 25 mM acetate buffer pH 5.0. The suspension was stirred for 30 min at room temperature (magnetic stirring). To each eppendorf tube was transferred 1.1 g of this suspension. Experimental pullulanase with an added carbohydrate binding module (CBM) having the sequence shown in SEQ ID NO: 2 (2000 NPUN/ml) was dosed at 0; 0.5; 2.5 and 5 NPUN/ml and compared to a pullulanase derived from Bacillus acidopullulyticus having the sequence shown in SEQ ID NO: 1 (1600 NPUN/g). All tests were prepared in double determinations. After enzyme addition, the solutions were mixed and incubated for 2 hours at 55° C. on an Eppendorf Thermomixer Comfort (1000 rpm). The enzyme reaction was terminated by placing the tubes in an Eppendorf Thermomixer Comfort (1000 rpm) for 10 min at 90° C. The samples were held (holding time) at 4° C. for 4 hours in order to facilitate the formation of resistant starch. After the holding time, the samples were quickly frozen at −40° C. (using shock freezing in Tecnomac). The frozen samples were freeze dried for 2 days in Heto Power Dry PL9000 from Holm & Halby. After freeze drying, the samples were analysed for resistant starch using Megazyme Resistant Starch Assay Procedure K-RSTAR 08/05 (AOAC Method 2002.02 and MCC Method 32-40). The results are given below:

| | | Resistant starch |
|---|---|---|
| Enzyme | Dose (NPUN/ml) | (g/100 g flakes) |
| Pullulanase (no CBM) | 0 | 1.9 |
| SEQ ID NO: 1 | 0.5 | 6.0 |
| | 2.5 | 9.4 |
| | 5.0 | 11.9 |
| Pullulanase (with CBM) | 0 | 1.9 |
| SEQ ID NO: 2 | 0.5 | 9.3 |
| | 2.5 | 14.0 |
| | 5.0 | 12.2 |

A higher resistant starch level is obtained at low dose levels when the pullulanase has a carbohydrate binding module attached.

### Example 10

Bintje potatoes (Grill-Kartoflen, Interfrugt Catering, Denmark) were manually peeled and cut into French fries using a French fry cutter (Taglia patate), size 0.8×0.8 cm. 60 g of potato sticks (from different potatoes) were sequentially blanched by transferring the sticks to a 4 L de-ionzed water bath at 85° C. for 4 min and subsequently to 160 ml de-ionized water preheated to 70° C. for 15 minutes. Each potato stick was equally cut into 10 pieces and divided into 10 portions of approx. 5 g potato. Debranching was performed using the following enzymes: Promozyme D2 (1350 NPUN/g) and Promozyme 400 L (1600 NPUN/g), both available from Novozymes ANS, Denmark, pullulanase derived from Bacillus acidopullulyticus having the sequence shown in SEQ ID NO: 1 (1600 NPUN/g) and experimental pullulanase with CBM (50.3 NPUN/g) having the sequence shown in SEQ ID NO: 2. The enzymes were evaluated in a concentration of 50 NPUN/g potato and the total liquid volume adjusted to 10 ml using 50 mM acetate buffer pH 5.0. For comparison a control was included just adding 10 ml 50 mM acetate buffer pH 5.0. All tests were prepared in duplicate. Debranching was performed at 55° C. for 16 hours in a water bath with no stirring. The enzyme was inactivated by heating the samples to 90° C. for 10 min. The water was drained and the samples were held (holding time) at 4° C. for 24 hours to facilitate the formation of resistant starch. The retrograded samples were manually mashed and the samples were analysed for resistant starch using Megazyme Resistant Starch Assay Procedure K-RSTAR 08/05 (AOAC Method 2002.02 and AACC Method 32-40). The dry solids content was subsequently determined after drying at 105° C.

The results are given below:

| | Resistant starch |
|---|---|
| Treatment | (g/100 g potato dry solids) |
| Control | 5.4 |
| SEQ ID NO: 1 | 9.2 |
| Promozyme D2 | 7.7 |
| SEQ ID NO: 2 | 4.2 |
| Promozyme 400 L | 6.2 |

Treating blanched potato sticks with pullulanase increased the content of resistant starch significantly in these.

### Example 11

Bintje potatoes (Grill-Kartoflen, Interfrugt Catering, Denmark) were manually peeled and cut into French fries using a French fry cutter (Taglia patate), size 0.8×0.8 cm. The potato sticks (from different potatoes) were divided into portions of 150 g and held in 400 ml de-ionized water until use. The potato sticks were sequentially blanched by dipping in 4 L de-ionzed water at 85° C. for 4 min and subsequently in 400 ml de-ionized water preheated to 70° C. for 15 minutes. Enzyme treatment was done in 300 ml 50 mM acetate buffer pH 5.0 using a pullulanase derived from Bacillus acidopullulyticus having the sequence shown in SEQ ID NO: 1 (1600 NPUN/g) at a concentration of 50 NPUN/g potato. For comparison a control in 300 ml 50 mM acetate buffer pH 5.0 without enzyme was included. All tests were prepared in duplicate. Debranching was performed at 55° C. for 4 hours in a water bath with no stirring. After enzyme treatment the potato sticks were dried in a ventilated heating cupboard for 10 min at 85° C. and parfried in vegetable oil for 1 min at 175° C. The parfried samples were held at 4° C. for 24 hours to facilitate the formation of resistant starch. The retrograded samples were manually mashed and analysed for resistant starch using Megazyme Resistant Starch Assay Procedure K-RSTAR 08/05 (AOAC Method 2002.02 and AACC Method 32-40). The dry solids content was subsequently determined after drying at 105° C.

Results are given below:

| | Resistant starch |
|---|---|
| Treatment | (g/100 g sample dry solids) |
| Control | 5.94 |
| Pullulanase SEQ ID NO: 1 | 7.51 |

Dry solids after parfrying was 35-36%. Treating blanched potato sticks with pullulanase followed by parfrying increased the content of resistant starch by approx. 26%.

### Example 12

Bintje potatoes (Grill-Kartoflen, Interfrugt Catering, Denmark) were manually peeled and cut into French fries using a French fry cutter (Taglia patate), size 0.8×0.8 cm. The potato sticks (from different potatoes) were divided into portions of 150 g and held in 400 ml de-ionized water until use. The potato sticks were sequentially blanched by dipping in 4 L de-ionzed water at 85° C. for 4 min and subsequently in 400 ml de-ionized water preheated to 70° C. for 15 minutes. Enzyme treatment was done in 300 ml 50 mM acetate buffer pH 5.0 using a pullulanase derived from Bacillus acidopullulyticus having the sequence shown in SEQ ID NO:1 (1600 NPUN/g) at a concentration of 50 NPUN/g potato. For comparison a control in 300 ml 50 mM acetate buffer pH 5.0 without enzyme was included. All tests were prepared in duplicate. Debranching was performed at 55° C. for 2 hours in a water bath with no stirring. After enzyme treatment the potato sticks were dried in a ventilated heating cupboard for 10 min at 85° C. and parfried in vegetable oil for 1 min at 175° C. The parfried samples were held at 4° C. for 72 hours to facilitate the formation of resistant starch. The cooled, retrograded potato sticks were second fried 3 min at 175° C. in vegetable oil. Afterwards they were manually mashed and analysed for resistant starch using Megazyme Resistant Starch Assay Procedure K-RSTAR 08/05 (AOAC Method 2002.02 and MCC Method 32-40). The dry solids content was subsequently determined after drying at 105° C.

Results are given below:

| | Resistant starch |
|---|---|
| Treatment | (g/100 g sample dry solids) |
| Control | 4.37 |
| Pullulanase SEQ ID NO: 1 | 5.40 |

Dry solids after second frying were between 50 and 55%. Treating blanched potato sticks with pullulanase followed by parfrying, cooling (for retrogradation) and second frying increased the content of resistant starch by approx. 24%.

### Example 13

Bintje potatoes (Grill-Kartoflen, Interfrugt Catering, Denmark) were manually peeled and cut into French fries using a French fry cutter (Taglia patate), size 0.8×0.8 cm. The potato sticks (from different potatoes) were divided into portions of 150 g and held in 400 ml de-ionized water until use. The potato sticks were sequentially blanched by dipping in 4 L de-ionzed water at 85° C. for 4 min and subsequently in 400 ml de-ionized water preheated to 70° C. for 15 minutes. Enzyme treatment was done in 300 ml 50 mM acetate buffer pH 5.0 using a pullulanase derived from Bacillus acidopullulyticus having the sequence shown in SEQ ID NO:1 (1600 NPUN/g) at a concentration of 50 NPUN/g potato. For comparison a control in 300 ml 50 mM acetate buffer pH 5.0 without enzyme was included. All tests were prepared in duplicate. Debranching was performed at 55° C. for 2 or 4 hours in a water bath with no stirring. After enzyme treatment the potato sticks were dried in a ventilated heating cupboard for 10 min at 85° C. and parfried in vegetable oil for 1 min at 175° C. The parfried samples were held at 4° C. for 48 hours to facilitate the formation of resistant starch. The retrograded samples were baked in the oven for 20 min at 180° C. Afterwards they were manually mashed and analysed for resistant starch using Megazyme Resistant Starch Assay Procedure K-RSTAR 08/05 (AOAC Method 2002.02 and AACC Method 32-40). The dry solids content was subsequently determined after drying at 105° C.

Results are given below:

| | Incubation time | Resistant starch |
|---|---|---|
| Treatment | (hrs) | (g/100 g sample dry solids) |
| Control | 2 | 3.7 |
| Pullulanase SEQ ID NO: 1 | 2 | 4.7 |
| Control | 4 | 4.5 |
| Pullulanase SEQ ID NO: 1 | 4 | 5.4 |

Dry solids after oven baking was 51% in average.

Treating blanched potato sticks with pullulanase followed by parfrying, cooling (for retrogradation) and baking in the oven increased the content of resistant starch by 20-27%. Increasing the incubation time increased the content of resistant starch.

1. Method for increasing the content of resistant starch in a potato product said method comprising the steps of:
a. providing an aqueous composition comprising a potato pre-product,
b. adjusting the temperature of the composition of step a) to a temperature suitable for enzymatic treatment of the potato pre-product by debranching enzymes,
c. treating the composition with one or more debranching enzymes, and d. holding the enzyme treated potato pre-product at a temperature of between −2 and 50° C.

2. A method in accordance with claim 1, wherein the potato pre-product is derived directly from a raw potato.

3. A method according with claim 1, wherein step d) is performed at a temperature and for a time period which induces formation of resistant starch in the enzyme treated potato pre-product.

4. A method in accordance with claim 1 comprising holding the enzyme treated potato pre-product at a temperature of between −2 and 30° C.

5. A method in accordance with claim 1 comprising holding the enzyme treated potato pre-product at a temperature of between −2 and 10° C.

6. A method in accordance with claim 1, wherein step d) is performed for a time period of between 10 minutes and 20 hours.

7. A method accordance with claim 1 comprising a step of heating the enzyme treated potato pre-product to a temperature of between 50° C. and 90° C.

8. A method in accordance with claim 1 comprising freezing the enzyme treated potato pre-product.

9. A method in accordance with claim 8 wherein the freezing step is performed as an instant freezing step where the enzyme treated potato pre-product is brought to a solid frozen state within a period of time of less than 5 minutes.

10. A method in accordance with claim 1 comprising an additional step of drying the enzyme treated potato pre-product.

11. A method in accordance with claim 10, wherein the additional step of freezing and the step of drying form a single step of freeze-drying the enzyme treated potato pre-product.

12. A method in accordance with claim 10 wherein the additional step of drying the enzyme treated potato pre-product is performed before step d) and step d) is carried out on a reconstituted dried enzyme treated potato pre-product.

13. A method in accordance with claim 1 comprising an additional step of partially drying of the enzyme treated potato pre-product to a dry matter content of no more than 80%.

14. A method in accordance with claim 13, wherein the additional step of partially drying the enzyme treated potato pre-product is performed before step d).

15. A method in accordance with claim 1, wherein retrograded starch is added to the enzyme treated potato pre-product before or during step d).

16. A method in accordance with claim comprising one or more pre- or post-treatment steps selected from the group comprising cutting, mashing, molding, pressing, frying, deep-frying, par-frying, cooking, bleaching, baking and leaching.

17. A method in accordance with claim 1, wherein the potato product is selected from the group consisting of potato granules, potato flakes, sliced potato chips, fabricated potato chips, extruded potato snacks, ground or crushed dehydrated potato dice and slice pieces, french fries, par-fried potato products, potato croquettes, potato nuggets, industrially pre-cooked potatoes, and mashed potato products such as cooled mashed potatoes and instant mashed potatoes.

18. A method according to claim 17 wherein the potato product comprises potato granules.

19-22. (canceled)

23. A method in accordance with claim 1, wherein said one or more debranching enzyme is selected from the group comprising amylo-alpha-1,6glucosidase, limit dextranase, pullulanase, isoamylase, and combinations thereof.

24. (canceled)

25. Method according to claim 23 wherein said debranching enzyme is an isoamylase or pullulanase.

26. (canceled)

27. A method in accordance with claim 23 wherein said debranching enzyme is a pullulanase comprising an amino acid sequence which has at least 70% identity with SEQ ID NO: 1 or a fragment thereof.

28. A method in accordance with claim 1, wherein said debranching enzyme is a hybrid polypeptide comprising a catalytic starch debranching domain and a starch binding domain.

29. A method in accordance with claim 28 wherein the starch binding domain belongs to one of the carbohydrate binding module families CBM-20, CBM-21, CBM-25, CBM-26, CBM-34, CBM-41 or CBM-45.

30. A method in accordance with claim 29 wherein the starch binding domain belongs to the CBM-20 family.

31. A method in accordance with claim 1, wherein said debranching enzyme comprises an amino acid sequence which has at least 70% identity with SEQ ID NO: 2.

32. A method in accordance with claim 1, wherein the amount of enzyme used is in the range of 10 microgram EP per ml suspension to 300 microgram EP per ml suspension.

33. A method in accordance with claim 1, wherein the treatment time in step c) is between 10 minutes and 20 hours.

34. A potato product comprising more than 5% resistant starch, wherein the potato product is obtainable by a process in accordance with claim 1.

35. A potato product in accordance with claim 34 comprising more than 10%, 20% or 30% resistant starch.

36-37. (canceled)

38. A potato product in accordance with claim 34, according to wherein the potato product is a product selected from the group consisting of potato granules, potato flakes, sliced potato chips, fabricated potato chips, extruded potato snacks, ground or crushed dehydrated potato dice and slice pieces, french fries, par-fried potato products, potato croquettes, potato nuggets, industrially pre-cooked potatoes, and mashed potato products such as cooled mashed potatoes and instant mashed potatoes.

39-50. (canceled)


SEQUENCE LISTING (2 sequences)

SEQ ID NO: 1 - protein, 829 aa, Bacillus acidopullulyticus
DSTSTEVIVHYHRFDSNYANWDLWMWPYQPVNGNGAAYEFSGKDDFGVKADVQVPGDDTQVGLIVRTNDWSQKNTSDDLHIDLTKGHEIWIVQGDPNIYYNLSDAQAAATPKVSNAYLDNEKTVLAKLTNPMTLSDGSSGFTVTDKTTGEQIPVTAATNANSASSSEQTDLVQLTLASAPDVSHTIQVGAAGYEAVNLIPRNVLNLPRYYYSGNDLGNVYSNKATAFRVWAPTASDVQLLLYNSETGPVTKQLEMQKSDNGTWKLKVPGNLKNWYYLYQVTVNGKTQTAVDPYVRAISVNATRGMIVDLEDTNPPGWKEDHQQTPANPVDEVIYEVHVRDFSIDANSGMKNKGKYLAFTEHGTKGPDNVKTGIDSLKELGINAVQLQPIEEFNSIDETQPNMYNWGYDPRNYNVPEGAYATTPEGTARITQLKQLIQSIHKDRIAINMDVVYNHTFNVGVSDFDKIVPQYYYRTDSAGNYTNGSGVGNEIATERPMVQKFVLDSVKYWVKEYHIDGFRFDLMALLGKDTMAKISKELHAINPGIVLYGEPWTGGTSGLSSDQLVTKGQQKGLGIGVFNDNIRNGLDGNVFDKSAQGFATGDPNQVNVIKNRVMGSISDFTSAPSETINYVTSHDNMTLWDKISASNPNDTQADRIKMDELAQAVVFTSQGVPFMQGGEEMLRTKGGNDNSYNAGDSVNQFDWSRKAQFENVFDYYSWLIHLRDNHPAFRMTTADQIKQNLTFLDSPTNTVAFELKNHANHDKWKNIIVMYNPNKTAQTLTLPSGNWTIVGLGNQVGEKSLGHVNGTVEVPALSTIILHQGTSEDVIDQN

SEQ ID NO: 2 - protein, 969 aa, Artificial Sequence
  Synthetic
MSLIRSRYNHFVILFTVAIMFLTVCFPAYKALADSTSTEVIVHYHRFDSNYANWDLWMWPYQPVNGNGAAYEFSGKDDFGVKADVQVPGDDTQVGLIVRTNDWSQKNTSDDLHIDLTKGHEIWIVQGDPNIYYNLSDAQAAATPKVSNAYLDNEKTVLAKLTNPMTLSDGSSGFTVTDKTTGEQIPVTAATNANSASSSEQTDLVQLTLASAPDVSHTIQVGAAGYEAVNLIPRNVLNLPRYYYSGNDLGNVYSNKATAFRVWAPTASDVQLLLYNSETGPVTKQLEMQKSDNGTWKLKVPGNLKNWYYLYQVTVNGKTQTAVDPYVRAISVNATRGMIVDLEDTNPPGWKEDHQQTPANPVDEVIYEVHVRDFSIDANSGMKNKGKYLAFTEHGTKGPDNVKTGIDSLKELGINAVQLQPIEEFNSIDETQPNMYNWGYDPRNYNVPEGAYATTPEGTARITQLKQLIQSIHKDRIAINMDVVYNHTFNVGVSDFDKIVPQYYYRTDSAGNYTNGSGVGNEIATERPMVQKFVLDSVKYWVKEYHIDGFRFDLMALLGKDTMAKISKELHAINPGIVLYGEPWTGGTSGLSSDQLVTKGQQKGLGIGVFNDNIRNGLDGNVFDKSAQGFATGDPNQVNVIKNGVMGSISDFTSAPSETINYVTSHDNMTLWDKISASNPNDTQADRIKMDELAQAVVFTSQGVPFMQGGEEMLRTKGGNDNSYNAGDSVNQFDWSRKAQFENVFDYYSWLIHLRDNHPAFRMTTADQIKQNLTFLDSPTNTVAFELKNHANHDKWKNIIVMYNPNKTAQTLTLPSGNWTIVGLGNQVGEKSLGHVNGTVEVPALSTIILHQGTSEDVIDQNPEPTPEPNTSQITFTVNNATTVWGQNVYVVGNISQLGNWDPVHAVQMTPSSYPTWTVTIPLLQGQNIQFKFIKKDSAGNVIWEDISNRTYTVPTAASGAYTASWNVP